(19) United States
(12) Patent Application Publication
(10) Pub. No.: US 2012/0243023 A1
(43) Pub. Date: Sep. 27, 2012

(54) OPTICAL SCANNING DEVICE, LIGHT CONTROL METHOD THEREFOR, AND IMAGE FORMING APPARATUS

(75) Inventor: Yuichi SEKI, Saitama-shi (JP)

(73) Assignee: CANON KABUSHIKI KAISHA, Tokyo (JP)

(21) Appl. No.: 13/425,969

(22) Filed: Mar. 21, 2012

(30) Foreign Application Priority Data
Mar. 23, 2011 (JP) 2011-064198

(51) Int. Cl. H04N 1/04; G06K 15/02

(52) U.S. Cl. 358/1.13; 358/475

(57) ABSTRACT

An optical scanning device controls outputs of laser beams with high accuracy by correcting the nonlinearity of a current-light characteristic. An electric current supply unit supplies a bias current or a driving current to a semiconductor laser. A detection unit detects light amount of the laser beam. A control unit controls the driving current based on the light amount detected. A constant current generation unit generates constant currents. A calculation unit derives an n-th degree approximate expression (n≧2) of a current-light characteristic based on the light amount by emitting a specific light emitting section according to the constant currents, and calculates a light emission start current start current for the specific light emitting section using the expression. A bias current generation unit generates the bias current based on electric current values obtained from results of light controls for other light emitting sections and the expression.

### BACKGROUND OF THE INVENTION

1. Field of the Invention

The present invention relates to an optical scanning device that controls emission of a semiconductor laser according to image data and scans a photoconductor by a laser beam emitted from the semiconductor laser, a light control method therefor, and an image forming apparatus.

2. Description of the Related Art

Japanese Laid-Open Patent Publication (Kokai) No. 2005-347477 (JP 2005-347477A) discloses an optical scanning device that can control optical output accurately even if luminescent characteristic that shows correlation between a driving current supplied to a semiconductor laser and the optical output (light amount) has nonlinearity.

The technique of JP 2005-347477A divides the inclination of the semiconductor laser's luminescent characteristic, which is determined by differential quantum efficiency of the semiconductor laser, a driving-current-setting DAC (Digital Analog Converter), and a full-scale setting DAC, into arbitrary sections, and controls the optical output of the semiconductor laser based on approximate optical power resolution obtained from the product of the differential quantum efficiency and the inclination that are calculated for every section. The approximate optical power resolution expresses the difference between the actual differential quantum efficiency of the laser and the collinear approximation. The resolution can be improved by collinearly approximating the luminescent characteristic in each of the divided sections. Specifically, the differential quantum efficiency is a value connected by a straight line, the inclination shows the laser driving current to a DAC set value, and the product thereof becomes laser intensity. When the number of sections increases, the collinear approximation becomes closer to the actual differential quantum efficiency of the laser, which improves the resolution.

In JP 2005-347477A, an arithmetic control circuit calculates a bias current that is almost equal to a threshold current of the semiconductor laser based on the differential quantum efficiency detected by a differential-quantum-efficiency detection unit, and controls the driving-current-setting DAC so as to output the bias current that is almost equal to the threshold current of the laser. This enables to obtain stable optical output from the laser.

However, since the technique of JP 2005-347477A uses the method of division approximation, it needs to cancel precision deterioration at the boundaries of the divided sections, and needs to increase the number of the sections in order to raise accuracy. Application to an analog circuit requires simplification of the circuit in order to avoid complication of the configuration. It is desired to control outputs of laser beams emitted from a multi-beam semiconductor laser with high accuracy.

### SUMMARY OF THE INVENTION

The present invention provides an optical scanning device, a light control method therefor, and an image forming apparatus, which are capable of controlling outputs of laser beams emitted from a multi-beam semiconductor laser with high accuracy by correcting the nonlinearity of the luminescent characteristic that shows correlation between a driving current supplied to the semiconductor laser and optical output.

Accordingly, a first aspect of the present invention provides an optical scanning device that scans an image bearing member with a laser beam emitted from a semiconductor laser modulated based on an image signal, comprising an electric current supply unit configured to supply one of a bias current and a driving current, which includes the bias current and a pulse current based on the image data, to the semiconductor laser, a detection unit configured to detect light amount of the laser beam emitted from the semiconductor laser, and a control unit configured to control the value of the driving current supplied to the semiconductor laser based on the light amount detected by the detection unit so that the light amount of the laser beam to which the image bearing member is exposed becomes a predetermined light amount, wherein the control unit comprising a constant current generation unit configured to generate a plurality of constant currents, an approximate expression derivation unit configured to derive an n-th degree approximate expression (n≧2) of a current-light characteristic based on the light amount detected by the detection unit by emitting a specific light emitting section of the semiconductor laser according to the constant currents generated by the constant current generation unit, and to calculate a light emission start current for the specific light emitting section using the n-th degree approximate expression concerned, and a bias current generation unit configured to generate the bias current based on electric current values obtained from results of light controls for light emitting sections other than the specific light emitting section and the n-th degree approximate expression derived by the approximate expression derivation unit.

Accordingly, a second aspect of the present invention provides a light control method for an optical scanning device that scans an image bearing member with a laser beam emitted from a semiconductor laser modulated based on an image signal, the light control method comprising a light amount detection step of detecting light amount of the laser beam emitted from the semiconductor laser, and a light control step of controlling the value of the driving current supplied to the semiconductor laser based on the light amount detected in the light amount detection step so that the light amount of the laser beam to which the image bearing member is exposed becomes a predetermined light amount, wherein the light control step comprising a constant current generation step of generating a plurality of constant currents, an approximate expression derivation step of deriving an n-th degree approximate expression (n≧2) of a current-light characteristic based on the light amount detected in the light amount detection step by emitting a specific light emitting section of the semiconductor laser according to the constant currents generated in the constant current generation step, and of calculating a light emission start current for the specific light emitting section using the n-th degree approximate expression concerned, and a bias current generation step of generating the bias current based on electric current values obtained from results of light controls for light emitting sections other than the specific light emitting section and the n-th degree approximate expression derived in the approximate expression derivation step.

Accordingly, a third aspect of the present invention provides an image forming apparatus provided with the optical scanning device of the first aspect.

According to the present invention, the outputs of the laser beams emitted from the multi-beam semiconductor laser can be controlled with high accuracy by correcting the nonlinearity of the luminescent characteristic.

Further features of the present invention will become apparent from the following description of exemplary embodiments with reference to the attached drawings.

### BRIEF DESCRIPTION OF THE DRAWINGS

FIG. 1 is a view schematically showing a configuration of an image forming apparatus according to an embodiment of the present invention.

FIG. 2 is a view schematically showing a configuration of an optical scanning device in FIG. 1.

FIG. 3A is a view showing positions of laser beams that are emitted from a semiconductor laser and scan a photosensitive drum.

FIG. 3B is a graph showing an example of an I-L characteristic that shows correlation between an electric current supplied to a semiconductor laser and light amount.

FIG. 4 is a flowchart showing a printing process by an image control device in FIG. 1.

FIG. 5 is a graph for describing an approximate expression derivation method for the I-L characteristic of the semiconductor laser.

FIG. 6A is a graph for describing a threshold current calculation method by high-order approximation.

FIG. 6B is a graph for describing a method to calculate the threshold current of each beam of the semiconductor laser according to an approximate expression.

FIG. 7A is a graph for describing the approximate expression obtained in this embodiment.

FIG. 7B is a graph showing a differential characteristic of the approximate expression.

FIG. 8 is a mode transition diagram showing operating states of a laser control device in this embodiment.

FIG. 9A is one part of a time chart showing the operating states of the laser control device.

FIG. 9B is the other part of the time chart showing the operating states of the laser control device following FIG. 9A.

FIG. 10A is a first part of a block diagram schematically showing the configuration of the laser control device in this embodiment.

FIG. 10B is a second part of the block diagram schematically showing the configuration of the laser control device in this embodiment.

FIG. 10C is a third part of the block diagram schematically showing the configuration of the laser control device in this embodiment.

FIG. 10D is a fourth part of the block diagram schematically showing the configuration of the laser control device in this embodiment.

FIG. 11A is one part of a state diagram showing output states of a switch and input states of data selectors in respective operations of the laser control device.

FIG. 11B is the other part of the state diagram showing ON/OFF states of bias switches and light emitting sections of the semiconductor laser in the respective operations of the laser control device.

FIG. 12A is a first part of a time chart showing light control including approximate expression derivation control and initial light control of the laser control device.

FIG. 12B is a second part of the time chart showing the light control including the approximate expression derivation control and the initial light control of the laser control device.

FIG. 12C is a third part of the time chart showing the light control including the approximate expression derivation control and the initial light control of the laser control device.

FIG. 12D is a fourth part of the time chart showing the light control including the approximate expression derivation control and the initial light control of the laser control device.

FIG. 13A is a first part of a time chart showing the light control including line-to-line light control of the laser control device.

FIG. 13B is a second part of the time chart showing the light control including the line-to-line light control of the laser control device.

FIG. 13C is a third part of the time chart showing the light control including the line-to-line light control of the laser control device.

FIG. 13D is a fourth part of the time chart showing the light control including the line-to-line light control of the laser control device.

FIG. 13E is a fifth part of the time chart showing the light control including the line-to-line light control of the laser control device.

FIG. 13F is a sixth part of the time chart showing the light control including the line-to-line light control of the laser control device.

### DESCRIPTION OF THE EMBODIMENTS

Hereafter, embodiments according to the present invention will be described in detail with reference to the drawings.

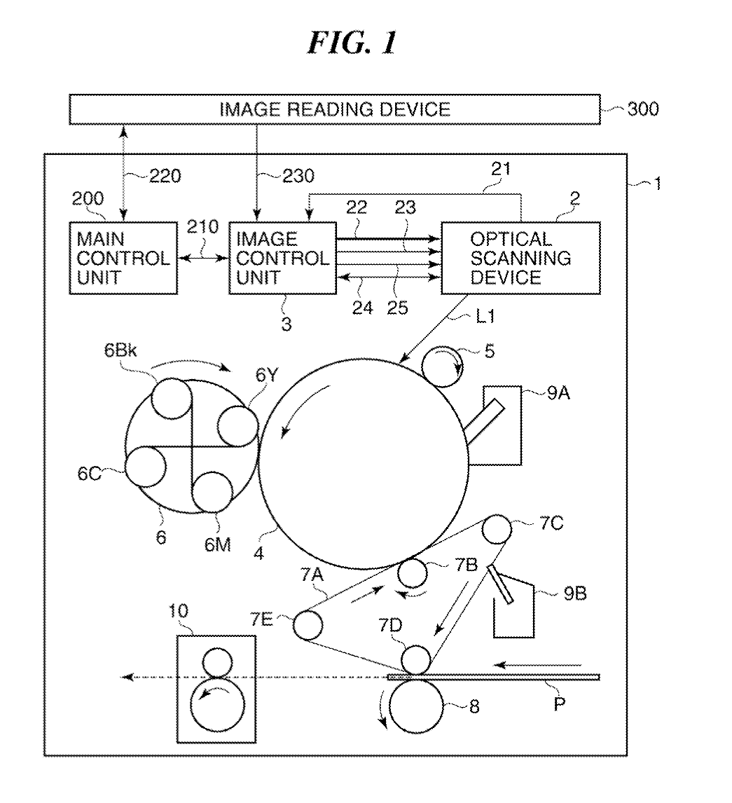

FIG. 1 is a view schematically showing a configuration of an image forming apparatus according to an embodiment of the present invention.

As shown in FIG. 1, the image forming apparatus 1 is connected to an image reading device 300 having a function to read an image of an original. It should be noted that the image reading device 300 may be built in the image forming apparatus 1 or may be separated therefrom. In the separated case, they are mutually connected via a cable or a network.

The image forming apparatus 1 is provided with a photosensitive drum 4 (photoconductor) as an image bearing member. The image forming apparatus 1 performs processes (a charging process, an exposure process, a developing process, and a transfer process) to form a toner image on the photosensitive drum 4 based on image information transmitted as a read image signal 230 from the image reading device 300, and then, performs a fixing process to fix the toner image onto a transfer sheet P. The image forming apparatus 1 is provided with a charging roller 5 as a charging unit, and uniformly charges the surface of the photosensitive drum 4 in predetermined electric potential by applying predetermined charging bias to the charging roller 5 (the charging process). Then, the image forming apparatus 1 converts image information about each of colors of yellow (Y), magenta (M), cyan (C), and black (Bk) transmitted from the image reading device 300 into image data by the image control device 3, and exposes the photosensitive drum by an optical scanning device 2 that emits a laser beam L1 sequentially (the exposure process). When the photosensitive drum 4 that is uniformly charged in the predetermined electric potential in the charging process is exposed to the laser beam L1 in the exposure process, an electrostatic latent image is formed on the photosensitive drum 4.

The image forming apparatus 1 has a development unit 6 that is provided with a plurality of development devices each of which contains development agent in which carrier and toner are mixed with a predetermined ratio for each color. The development unit 6 has a yellow development device 6Y that includes yellow development agent, a magenta development device 6M that includes magenta development agent, a cyan development device 6C that includes cyan development agent, and a black development device 6Bk that includes black development agent. In a developing process, these development devices 6Y, 6M, 6C, and 6Bk sequentially transfer the development agents to a latent image formed on the photosensitive drum 4 to form a toner image on the photosensitive drum 4. When the yellow development device 6Y form a a toner image on the photosensitive drum 4, the image forming apparatus 1 transfers the formed toner image to an intermediate transfer belt 7A by a transfer roller 7B. Subsequently, a toner image formed by the magenta development device 6M is transferred to the intermediate transfer belt 7A by overlaying on the previous toner image. Thus, four color toner images are overlaid on the intermediate transfer belt 7A by the development devices 6Y, 6M, 6C, and 6Bk.

The toner image transferred from the photosensitive drum 4 to the intermediate transfer belt 7A is transferred to a desired transfer sheet P by a transfer roller 8 (a transfer process). A fixing device 10 fixes the not-fixed toner image onto the transfer sheet P (a fixing process).

A main control unit 200 is connected to the image reading device 300, and controls the image reading device 300 by an image reading control signal 220. The main control unit 200 is connected to an image control unit 3, and controls the image control unit 3 by an image control signal 210. The image control unit 3 is connected to the optical scanning device 2, and exchanges a beam detection signal 21, a laser control signal 22, image data 23, a motor control signal 24, and a bias setting signal 25 (mentioned later) with the optical scanning device 2.

Next, an outline configuration of the optical scanning device 2 will be described.

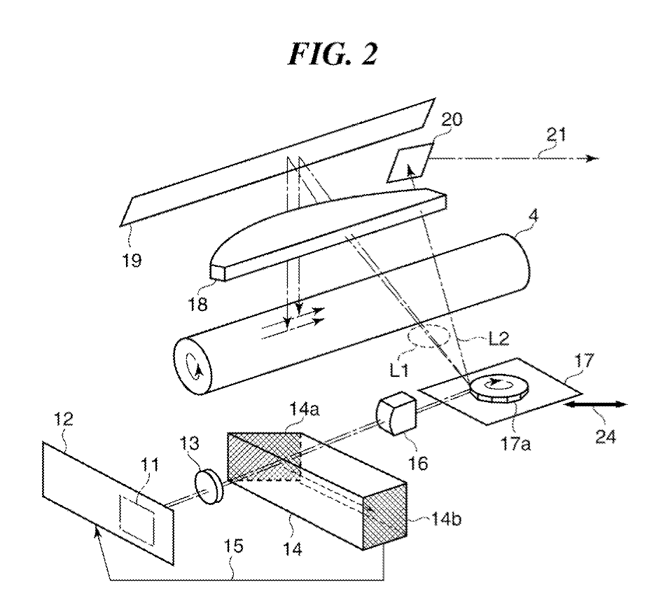

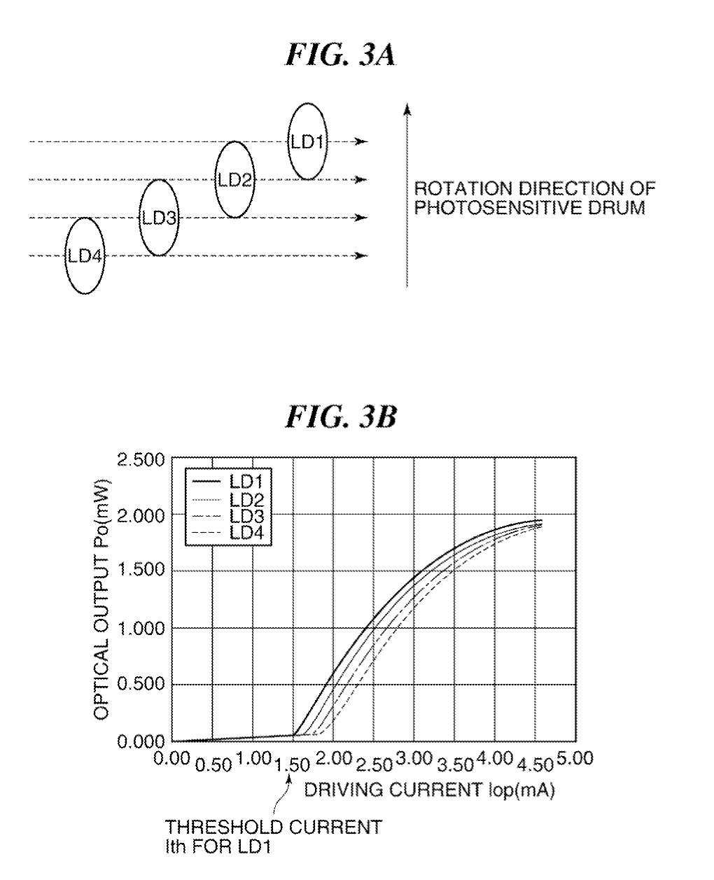

FIG. 2 is a view schematically showing the configuration of the optical scanning device 2 in FIG. 1. FIG. 3A is a view showing positions of laser beams that are emitted from a semiconductor laser and scan the photosensitive drum 4.

In FIG. 2, the semiconductor laser 11 in this embodiment is a surface emitting laser that is provided with four light emitting sections LD1 through LD4 and can emit four laser beams at the same time. On the photosensitive drum 4, the four laser beams are imaged at positions that are separated at predetermined intervals in the principal scanning direction and the auxiliary scanning direction, as shown in FIG. 3A. The ellipses of the symbols LD1 through LD4 in FIG. 3A show the imaging points of the laser beams LD1 through LD4 on the photosensitive drum 4. The spot formed by the laser beam emitted from the light emitting section LD1 is positioned at the top in the principal scanning direction and the auxiliary scanning direction. The principal scanning direction is almost parallel to a rotating axial direction (the direction shown by arrows of dotted lines in FIG. 3A). The auxiliary scanning direction is a rotation direction of the photosensitive drum 4. A laser control device 12 controls a driving current based on a monitor current signal 15 outputted from the light amount detection unit 14 so that the semiconductor laser 11 emits in a predetermined light amount.

The light amount detection unit (referred tows a “PD unit” in short hereafter) 14 is provided with a partial reflection mirror 14a and a photodetector (referred to as a “PD” in short hereafter) 14b in its inside. The partial reflection mirror 14a reflects a part of light intensity (light amount) of a laser beam that is emitted from the semiconductor laser 11 and passes a collimator lens 13. The PD 14b receives a beam from the semiconductor laser 11 reflected by the partial reflection mirror 14a, and outputs the monitor current signal 15.

The laser beam emitted from light emitting section LD1 of the semiconductor laser 11 reaches a polygon mirror 17a through the collimator lens 13 and a cylindrical lens 16. The polygon mirror 17a is rotated with constant angular speed by the scanner motor unit 17 including a scanner motor. The laser beam is deflected by the polygon mirror 17a, and it is converted by an f-θ lens 18 so as to scan the photosensitive drum 4 at a constant speed in the principal scanning direction. A beam detection sensor (referred to as a “BD sensor” in short hereafter) 20 is arranged at a position within a non-image area in the principal scanning direction. A laser beam enters into the BD sensor 20 once per one scan. When the laser beam L2 enters into the BD sensor 20, the BD sensor 20 outputs a beam detection signal (referred to as a “BD signal” in short hereafter) 21 for determining an image position in the principal scanning direction.

On the other hand, the laser beam L1 within an image area reaches the photosensitive drum 4 via a reflective mirror 19 after passing through the f-θ lens 18. Accordingly, an electrostatic latent image is formed on the photosensitive drum 4.

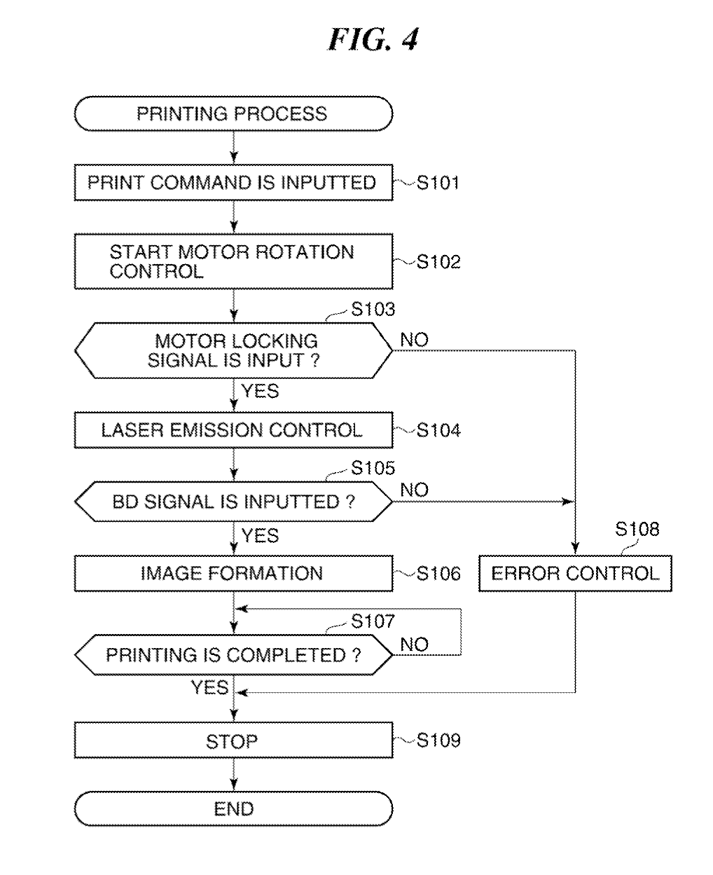

FIG. 4 is a flowchart showing a printing operation (a printing process) by the image control device 3 in FIG. 1.

When the image control-signal 21 (a print command) is inputted from the main control unit 200 (step S101), the image control unit 3 outputs a motor control signal 24 (a rotating operation signal) to the scanner motor unit 17 in the optical scanning device 2, and makes a rotation control start (step S102).

Next, the image control unit 3 determines whether the motor control signal 24 (a motor locking signal) was inputted from the scanner motor unit 17 (step S103). When an input is detected (YES in the step S103), the image control unit 3 outputs the laser control signal 22 to the laser control device 12, and shifts to an emission control for the semiconductor laser 11 (step S104).

Next, the image control unit 3 shifts to a BD signal detection mode for determining whether the BD signal 21 was inputted (step S105). When a prescribed number of BD signals 21 are inputted (YES in the step S105), the image control unit 3 outputs image data 23 to the laser control device 12, and the image forming apparatus 1 performs the image formation process mentioned above (steps S106 and S107). When the printing is completed (YES in the step S107), the image control unit 3 controls the scanner motor unit 17 to stop, controls the laser control device 12 to turn off the semiconductor laser 11, and stops the optical scanning device 2 (step S109).

On the other hand, the image control unit 3 determines as an operation error of the optical scanning device 2 when an input signal is not detected in the motor locking signal detection step (step S103) or the BD signal detection step (step S105). The image control unit 3 outputs the image control signal 210 (an error signal) to the main control unit 200 (step S108), and then, controls the optical scanning device 2 to stop (step S109).

FIG. 3B is a graph showing an example of an I-L characteristic (a current-light characteristic) that represents the relation between an electric current (a driving current Iop [mA]) of the semiconductor laser 11 and light amount (optical output Po [mW]). As shown in FIG. 3B, the optical output (light amount) of the light emitting section LD1 hardly increases even if the driving current Iop increases up to about 1.50 mA of the driving current Iop. However, when the driving current Iop exceeds a threshold current Ith near 1.500 mA, the increasing rate of the optical output to the driving current Iop becomes larger than that in the electric current region below the threshold current. In the case of the illustrated characteristic, the threshold current Ith for the light emitting section LD1 is 1.500 mA, the threshold current Ith for the light emitting section LD2 is 1.625 mA, the threshold current Ith for the light emitting section LD3 is 1.750 mA, and the threshold current Ith for the light emitting section LD4 is 1.875 mA.

The laser control device 12 supplies the bias currents near the respective threshold currents to the light emitting sections LD1 through LD4 of the semiconductor laser 11. The bias current is set so that the laser beam emitted by the bias current does not change the electric potential of the photosensitive drum 4 (the details will be mentioned later). When forming dots based on the image data on the photosensitive drum 4, the laser control device 12 supplies the driving current that superimposes a switching current (a pulse current) generated based on the inputted image data (image information) upon the above-mentioned bias current to each of the light emitting sections LD1 through LD4 of the semiconductor laser 11. That is, the laser control device 12 supplies the bias currents as standby currents to the light emitting sections LD1 through LD4 even in timing of not forming a dot on the photosensitive drum 4 during the image formation. This shortens a time lag between supplying the switching currents to the light emitting sections LD1 through LD4 and reaching a predetermined value of the light amount of the laser beams (improvement in a light emission response).

The surface emitting laser provided with the plurality of light emitting sections has nonlinear luminous efficiency (η) in the current region beyond the threshold current Ith as shown in FIG. 3B. There is an experimental result that the I-L characteristic of the semiconductor laser 11 with a surface emitting structure can be almost expressed by a quartic approximation and that a main factor of deviations among the beams is the variation in the threshold currents (Ith) rather than the uniform luminous efficiencies. Next, an approximate expression derivation method for the I-L characteristic in this embodiment will be described.

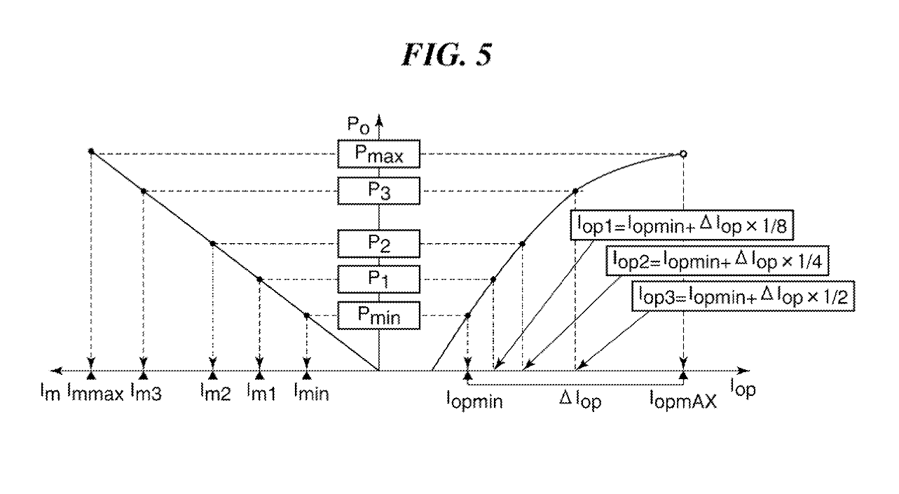

FIG. 5 is a graph for describing the approximate expression derivation method (calculation method) for the I-L characteristic of the semiconductor laser 11. In the method described below, the I-L characteristic will be approximated with the quartic approximate expression using five constant current values. It should be noted that the order and the constant current values of the approximate expression are available even if they are more than the written values.

The light amount value (the maximum light amount) that can be outputted by a predetermined light emitting section of the semiconductor laser 11 is detected, and the driving current supplied to the predetermined light emitting section when emitting the maximum light amount is determined as the maximum driving current (Iopmax). The maximum light amount refers to the light amount value (near the driving current Iop 4.50 mA) where the luminous efficiency is “0” (an inflection point) as shown by the I-L characteristic in FIG. 3B.

The value of the driving current by which the light amount of the laser beam detected by the PD 14 becomes 25% (the minimum light amount) of the maximum light amount of the predetermined light emitting section is the minimum driving current (Iopmin). Although the minimum light amount is determined as 25% of the maximum light amount in this embodiment, since the maximum light amount varies with characteristics of a semiconductor laser, the ratio to the maximum light amount can be arbitrarily determined without limiting to 25% (the ratio to the maximum light amount is larger than 0% and is smaller than 100%).

Since the luminous efficiency increases neat the threshold current like the I-L characteristic shown in TIG. 3B, the constant currents (Iop₁, Iop₂, Iop₃) are generally set as values smaller than the median between Ippmax and Iopmin shown in FIG. 5. One example of setting of the constant currents will be described below. However, the setting ratio may be arbitrarily determined. It should be noted that a differential current between Iopmax and Iopmin is set to ΔIop.

The median between Iopmax and Iopmin is set to Iop₃ (=Iopmin+ΔIop*1/2).

The median between Iop₃ and Iopmin is set to Iop₂ (=Iopmin+ΔIop*1/4).

The median between Iop₂ and Iopmin is set to Iop₁ (=Iopmin+ΔIop*1/8).

An approximate expression is derived by calculating coefficients of the following quartic expressions based on the above-mentioned five constant current values (Iopmin, Iop₁, Iop₂, Iop₃, and Iopmax) and the monitor current signals 15 that are obtained when the semiconductor laser 11 is driven in these constant current values.

Pmax=Immax=a(Iopmax)⁴+b(Iopmax)³+c(Iopmax)²+d(Iopmax)+e

P₁=Im₁=a(IOp₁)⁴+b(Iop₁)³+c(Iop₁)²+d(Iop₁)+e

P₂=Im₂=a(Iop₂)⁴+b(Iop₂)³+c(Iop₂)²+d(Iop₂)+e

P₃=Im₃=a(Iop₃)⁴+b(Iop₃)³+c(Iop₃)²+d(Iop₃)+e

Pmin=Immin=a(Iopmin)⁴+b(Iopmin)¹+c(Iopmin)²+d(Iopmin)+e

(a, b, c, d, and e: constants)

In the graph shown in FIG. 5, the vertical axis expresses the light amount Po for both a first quadrant and a second quadrant. Then, the horizontal axis of the first quadrant expresses the laser driving current Iop and the horizontal axis of the second quadrant expresses the output current Im of the PD 14b that receives a laser beam. The output current Im is in an illustrated proportional relation with the light amount Po according to the characteristic of the PD. Therefore, since the light amount Po can be calculated based on the measurement result of the output current Im, the relation between the output current Im and the laser driving current Iop can be approximated by the above-mentioned expression.

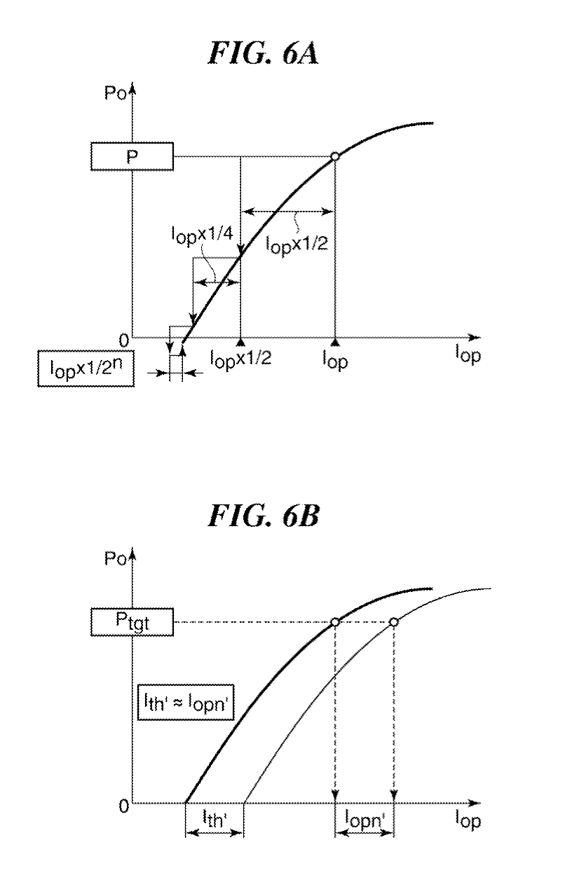

FIG. 6A is a graph for describing a threshold current calculation method by high-order approximation.

In this embodiment, the laser driving current Iopₙ when the light amount value of the above-mentioned approximate expression is “0” (i.e., Pₙ (n: Pmin, P₁, P₂, P₃, Pmax)=0) in the quadrant expresses mentioned above is regarded as the threshold current Ith. Then, the set light amount P corresponding to the set current Iop for the semiconductor laser 11 is calculated based on the above-mentioned approximate expression. When the set light amount P is equal to or more than “0”, the light amount P is calculated by reducing the set current Iop half. When the light amount value P obtained from the approximate expression corresponding to the set current Iop becomes smaller than “0” while repeating the similar calculation, one half of the last electric current value is added. The set current value Iop when the light amount P gets close to “0” is regarded as the threshold current Ith as a result of the above mentioned successive approximation. It should be noted that the set light amount P can be selected from among the light amount values used when the approximate expression is derived.

FIG. 6B is a graph for describing a method to calculate the threshold current of each of the light emitting sections LD1 through LD4 of the semiconductor laser 11 according to the approximate expression.

In order to calculate the threshold current of each of the light emitting sections, target light amount Ptgt of one of four beams is determined by the light control. Then, a differential current Iopₙ′ between the driving current value Ioptgt acquired from the target light amount Ptgt and the driving current value Ioptgt corresponding to the same light amount value obtained by the above-mentioned approximate expression is calculated. The P-Iop characteristic shown in FIG. 6B shows that the differential current Iopₙ′ is almost the same as the difference Ith′ among the threshold current values of the light emitting section. The threshold current of other light emitting sections can be computed using the difference Ith′ based on the similarity of the P-Iop characteristic of all the light emitting sections.

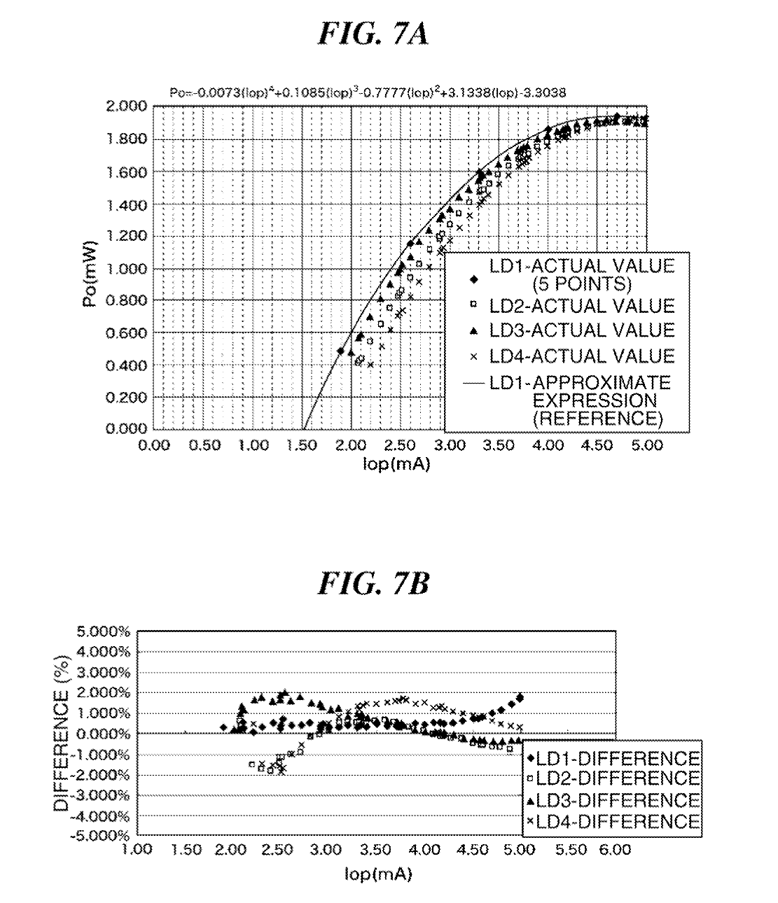

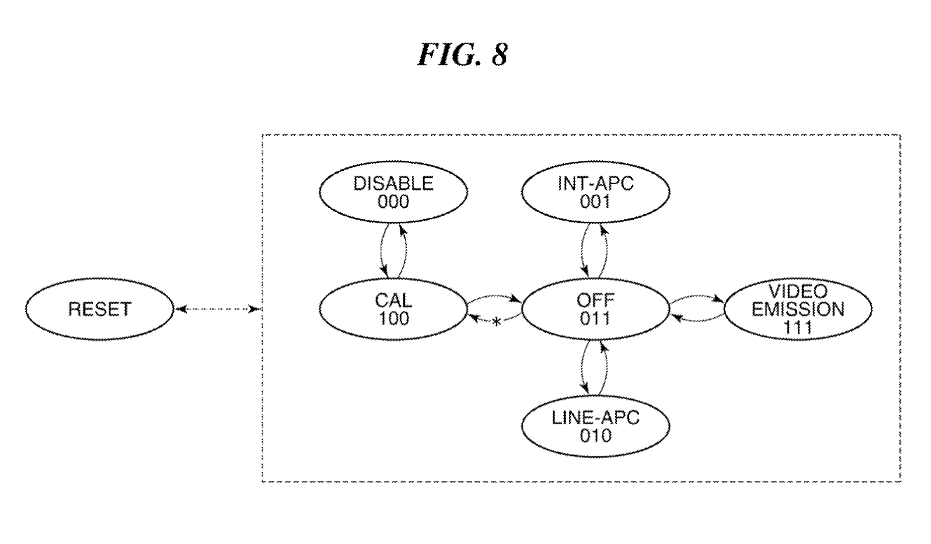

FIG. 7A is a graph for describing the approximate expression obtained in this embodiment. FIG. 7B is a graph showing one example of the differential characteristic of the approximate expression.

The approximate expression shown in FIG. 7A is a result that was obtained based on the characteristic of the light emitting section LD1 of the semiconductor laser 11 according to the above-mentioned algorithm. FIG. 7B shows that differences between the light amount values computed using the approximate expression and the actual measurement values of the light emitting sections of the semiconductor laser 11 are smaller than about 2% in a range below the maximum light amount.

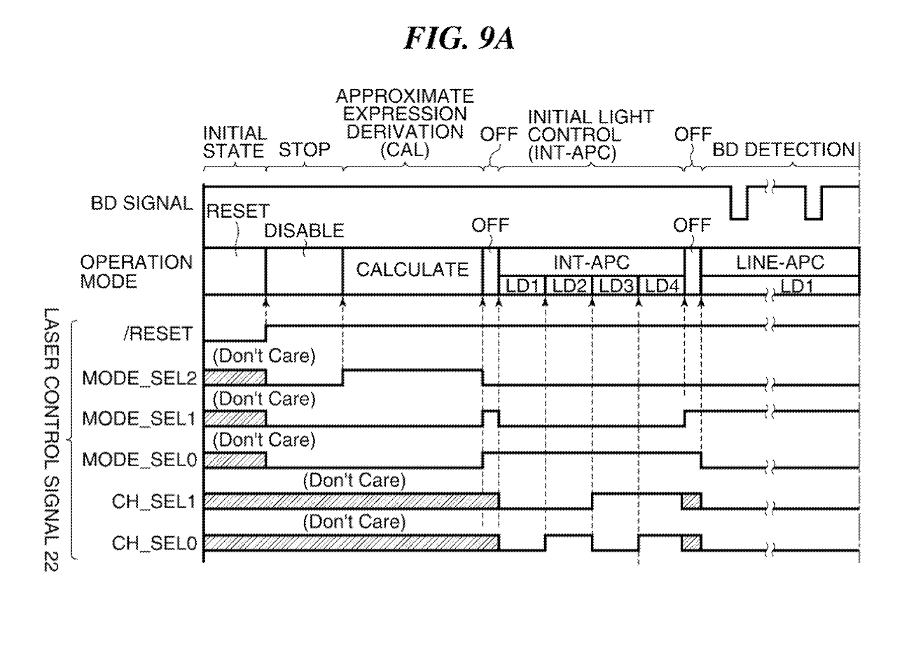

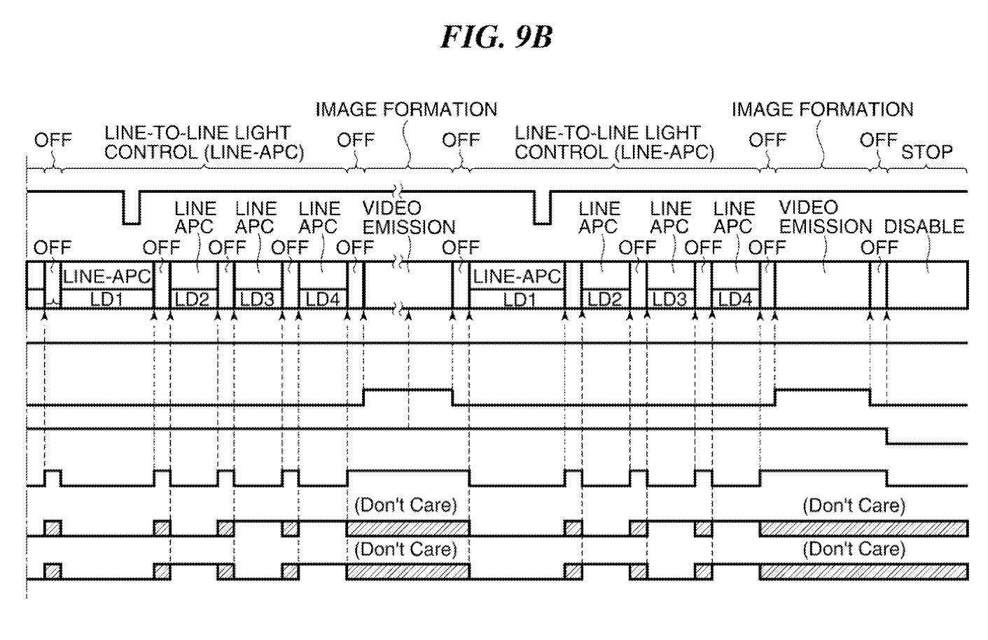

FIG. 8 is a mode transition diagram showing operating states of the laser control device 12 in this embodiment. FIG. 9A and FIG. 9B show a time chart showing the operating states of the laser control device 12.

The laser control device 12 sequentially changes its operation mode among the six operation modes in the dotted-line rectangle in FIG. 8 according to the laser control signal 22. That is, the laser control device 12 executes a sequence of the following steps (1) through (7) in the printing process shown in FIG. 4.

### (1) Stop

(2) Approximate expression derivation control (CAL)
(3) Initial light control (INT-APC)

### (4) BD_detection

(5) Line-to-line light control (LINE-APC)
(6) Image formation
(7) Initial state (RESET)

The laser control signal 22 comprises six signal groups (/RESET, MODE_SEL0, MODE_SEL1, MODE_SEL2, CH_SEL1, and CH_SEL0). A three-digit string written in an ellipse of each operation mode in FIG. 8 indicates the control signal states of the laser control signal 22 (MODE_SEL2, MODE_SEL1, and MODE_SEL0), and “0” represents “L” level of a signal and “1” represents “H” level of a signal. The main specifications of the laser control device 12 are shown below.

Laser control device 12/Main specification
Current capacity: 10 [mA]
Number of output beams: Four [beam]
Resolution: 9 [bit]

Next, a control method executed when the laser control device 12 with the above-mentioned specification controls the semiconductor laser 11 will be described.

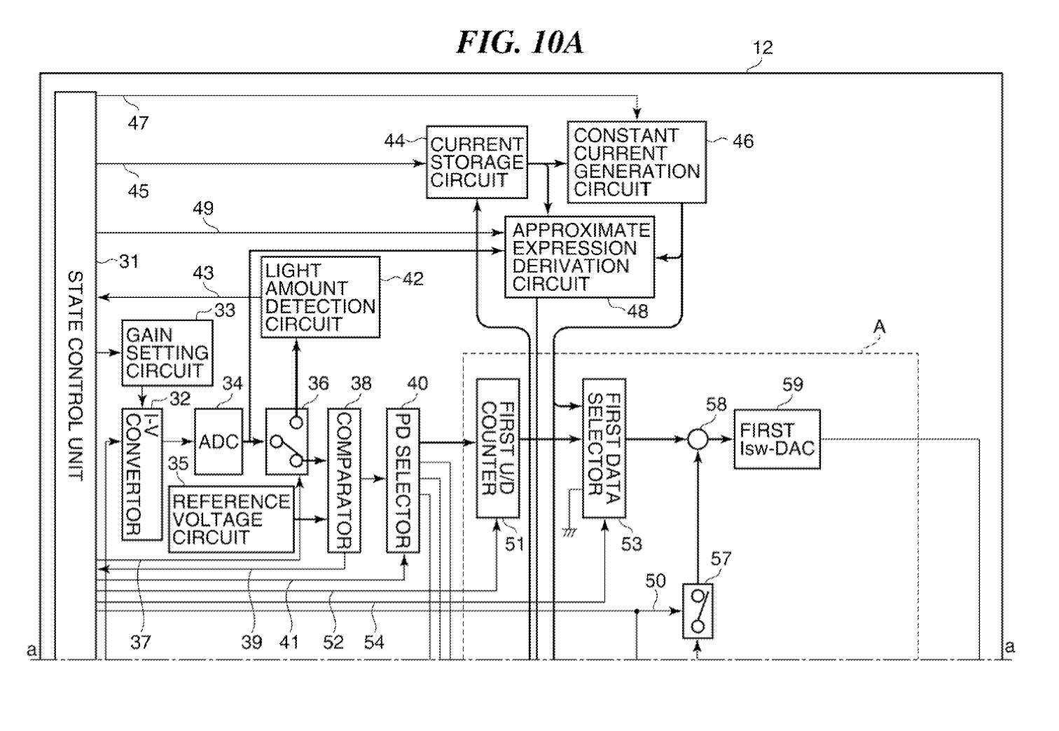

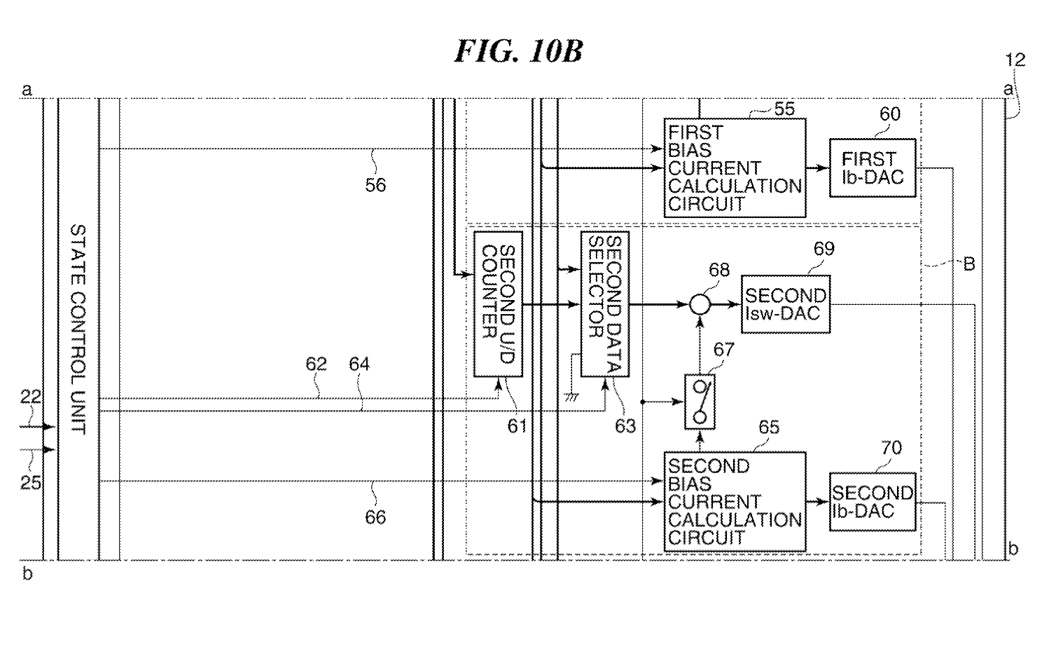

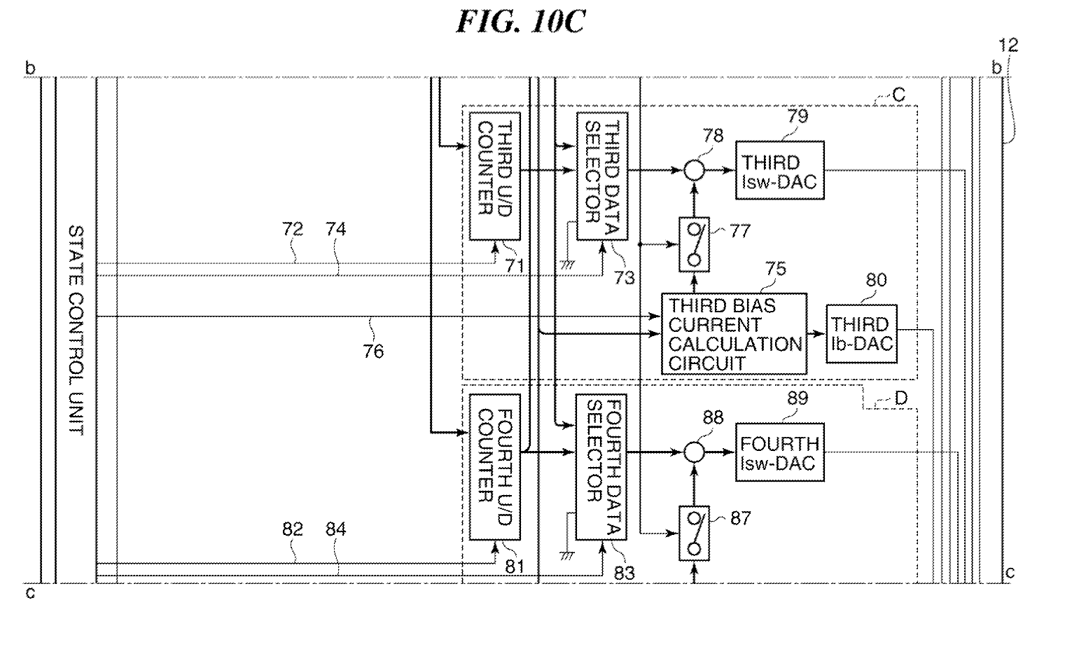

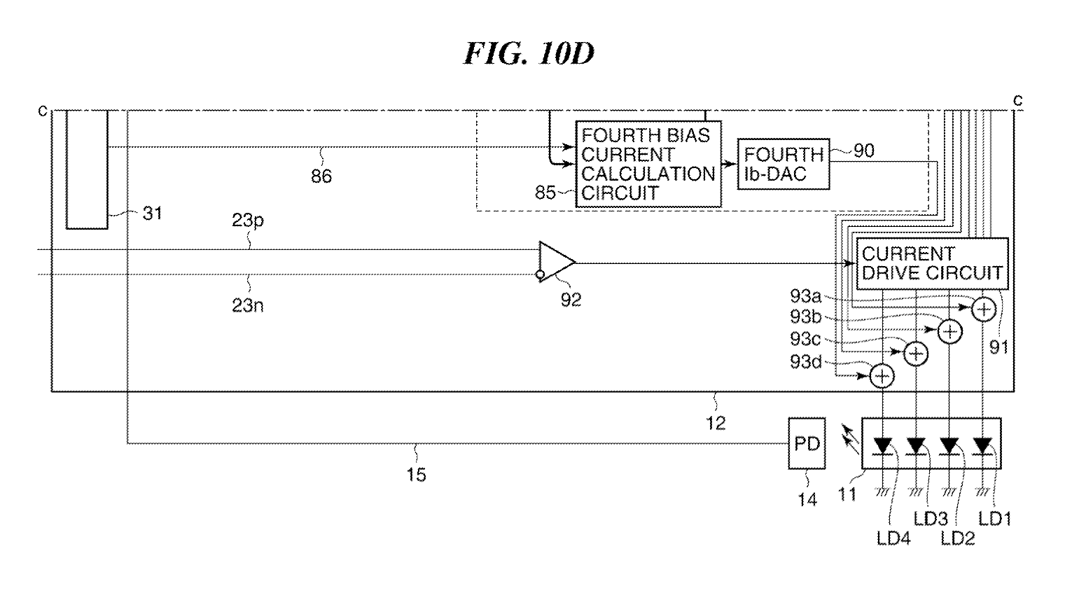

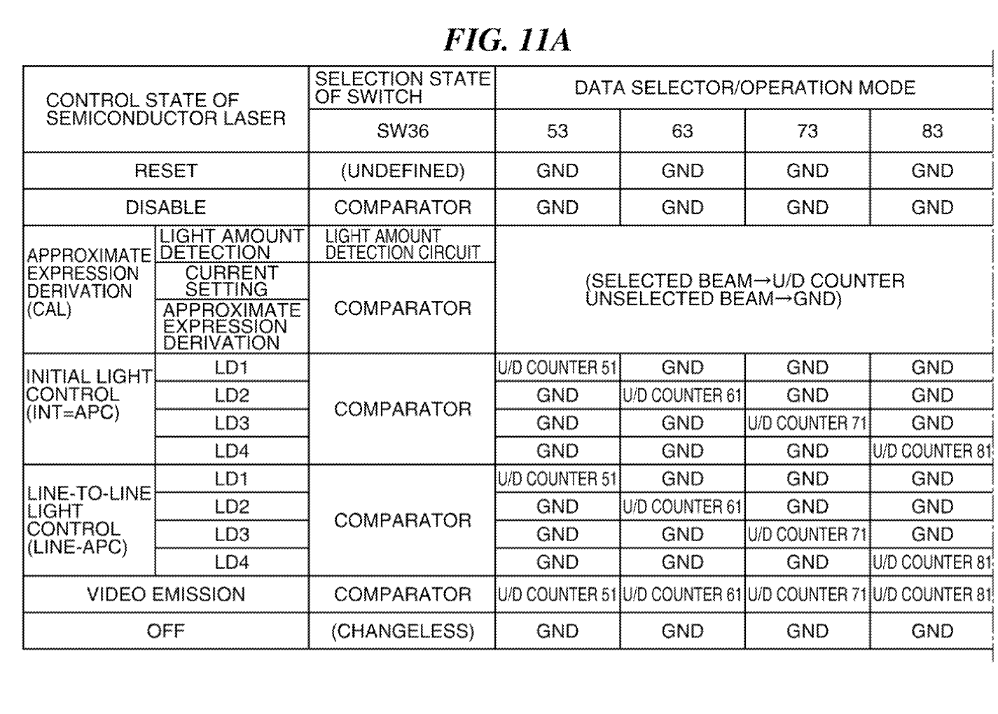

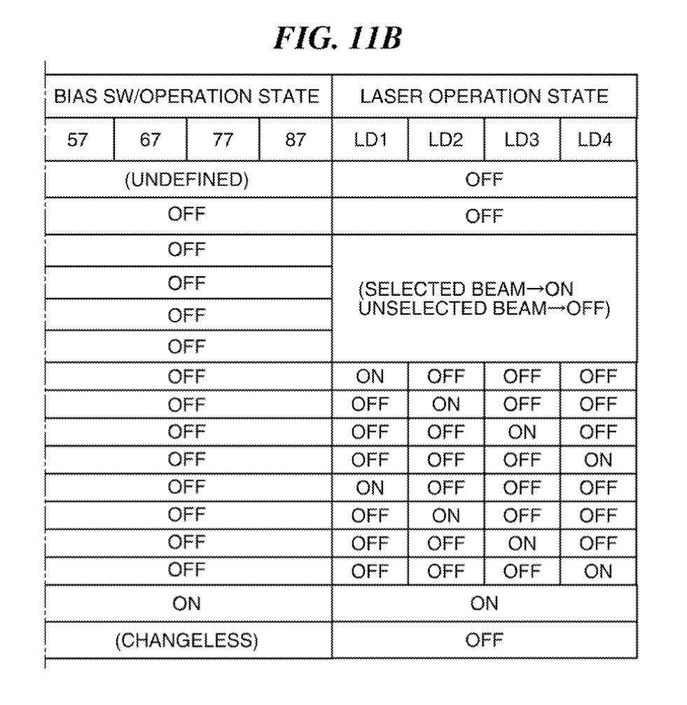

FIG. 10A through FIG. 10D show a block diagram of the schematic configuration of the laser control device 12 in this embodiment. FIG. 11A and FIG. 11B show a state diagram showing the output states of the switch 36, the input states of the first, second, third, and fourth data selectors 53, 63, 73, and 83, the ON/OFF states of the bias switches 57, 67, 77, and 87, and the ON/OFF states of the light emitting sections LD1 through LD4 in each operation of the laser control device 12.

The laser control device 12 receives the laser control signal 22, the bias setting signal 25, and four sets of differential image data 23 from the image control unit 3, controls the outputs of the light emitting sections LD1 through LD4 of the semiconductor laser 11, and receives the monitor current signal 15 from the PD unit 14. A state control unit 31 sets up each block arranged in the laser control device 12 according to the laser control signal 22. The monitor current signal 15 inputted from PD unit 14 is amplified corresponding to an output value of a gain setting circuit 33, and is converted into a voltage signal by a current-voltage conversion circuit (referred to as an “I-V converter” in short, hereafter) 32.

The converted voltage signal is quantized by an analog-digital converter (referred to as an “ADC” in short, hereafter) 34, and then, the quantized signal is selectively outputted to a comparator 38 or a light amount detection circuit 42 by a switch 36. The comparator 38 compares the output of the ADC 34 with the output of a reference voltage circuit 35, and sends the output result to a PD selector 40. The PD selector 40 is connected to modules A, B, C, and D, and selectively sends the output of the comparator 38 to the module A, B, C, or D based on a PD selection signal 41 inputted from the state control unit 31.

The light amount detection circuit 42 detects the output value of the ADC 34, and outputs a light amount detection signal 43 when it is determined that the light amount of the semiconductor laser 11 reaches the maximum light amount. For example, when the same output value or the decreasing output value is continuously detected twice; the light amount detection circuit 42 determines that the light amount is maximized.

The modules A through D are: current setting modules corresponding to the light emitting sections LD1 through LD4 of the semiconductor laser 11, respectively. The current setting module A corresponding to the light emitting section LD1 will be described as an example. It should be noted that since each of the modules B, C, and D has the same configuration as the module A, the description is omitted.

A first up/down counter (referred to as a “first U/D counter” in short, hereafter) 51 performs three kinds of operations including count-up/down, stop, and initial value (“000h”) setting, according to a counter control signal 52. According to a selector control signal 54, the first data selector 53 selects from among the output of the first U/D counter 51, an output of a constant current generation circuit 46, and GND, and outputs the selected signal. The output of the first data selector 53 is converted into an analog signal by a first switching current digital-to-analog converter (referred to as a “first Isw-DAC” in short hereafter) 59 via a first subtracter 58, and serves as the driving current for the semiconductor laser 11.

On the other hand, a current storage circuit 44 stores and reads (through) the output of the first U/D counter 51 at a prescribed timing, and transmits it to the constant current generation circuit 46 and an approximate expression derivation circuit 48 (calculation circuit) in the later stage. The constant current generation circuit 46 calculates a constant current value based on the output of the current storage circuit 44 according to a predetermined algorithm and outputs it to the first data selector 53 in an “approximate expression derivation control” sequence described below.

The approximate expression derivation circuit 48 is connected with the current storage circuit 44 and the light amount detection circuit 42, derives an approximate expression based on the output of the current storage circuit 44 in the “approximate expression derivation control” sequence according to the predetermined algorithm, and calculates an electric current value (a light emission start current Ith) that is equivalent to the threshold current of the semiconductor laser 11. Then, the electric current value concerned is outputted to a first bias current calculation circuit 55.

The first bias current calculation circuit 55 generates the electric current value equivalent to the threshold current calculated by the approximate expression derivation circuit 48 based on a bias setting signal 56, outputs the acquired bias current value to a first bias current digital-to-analog converter (referred to as a “first Ib-DAC” in short hereafter) 60, and outputs it to the first subtracter 58 via a first bias switch 57. Thus, the first bias current calculation circuit 55 functions as a bias current generation unit

The first bias switch 57 opens to output the output value of the first data selector 53 to the first Isw-DAC 59 except in the “VIDEO EMISSION” mode shown in FIG. 8. In the “VIDEO EMISSION” mode, the first bias switch 57 is short-circuited so that the first subtracter 58 subtracts the output value of the first bias current calculation circuit 55 from the input value of the first Isw-DAC 59. This divides the driving current for the semiconductor laser 11 into the switching current Isw and the bias current Ib. The relation between the threshold current (the light emission start current) Ith and the bias current Ib has the relation of Ib=αIth (α≦1).

A current drive circuit 91 modulates the output of the first Isw-DAC 59 by image data 23p and 23n that is inputted from the image control unit 3 via a data driver 92. An adder 93a adds the output of the first Ib-DAC 60 to the output of the current drive circuit 91, and serves as the driving current for the light emitting section LD1 of the semiconductor laser 11.

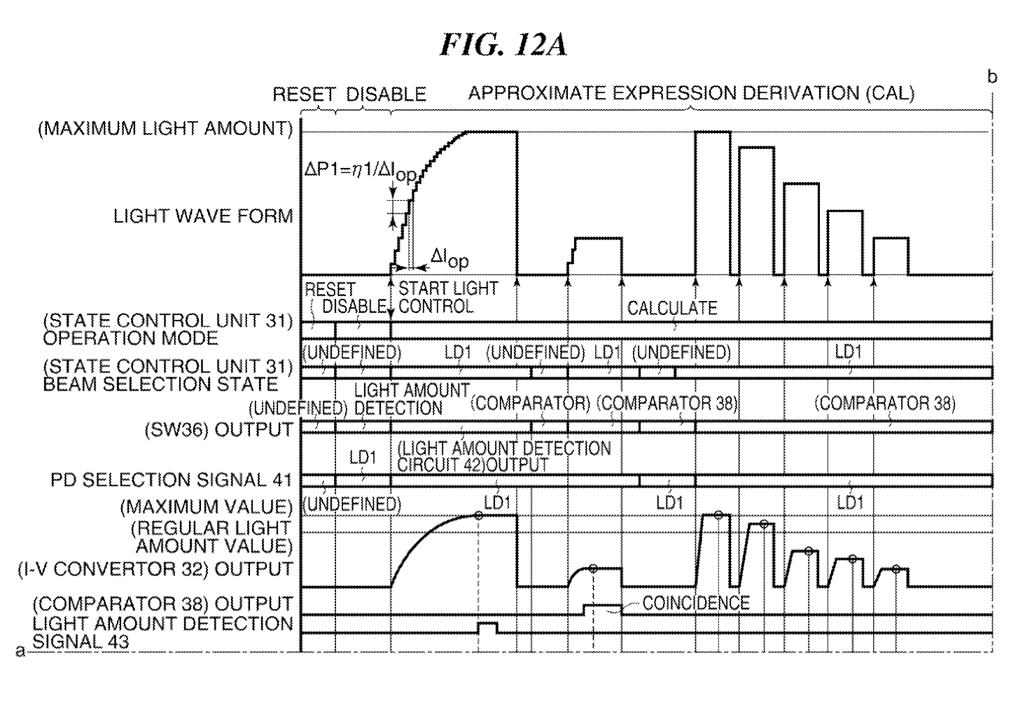

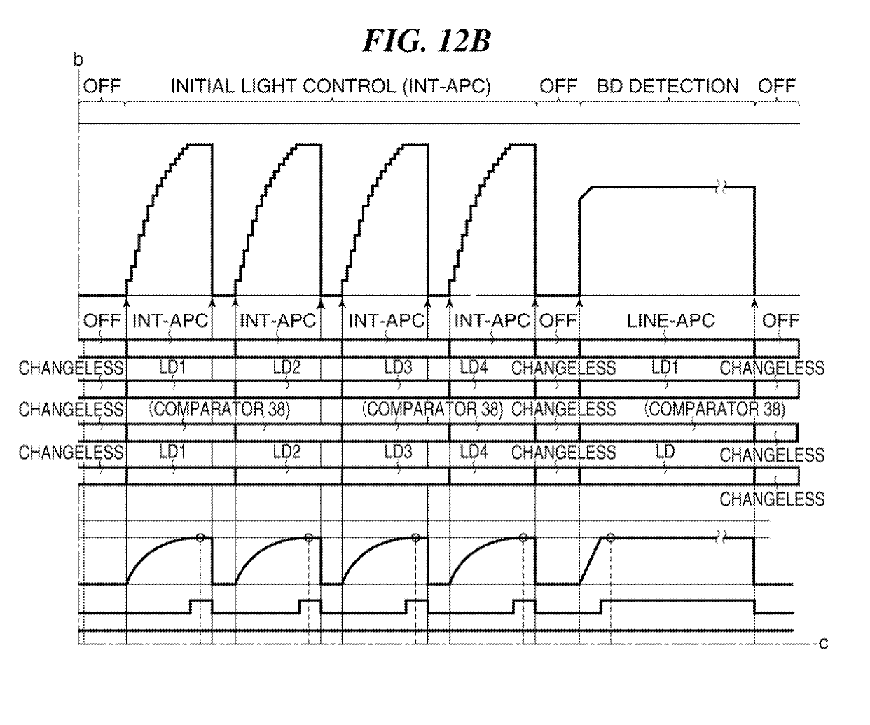

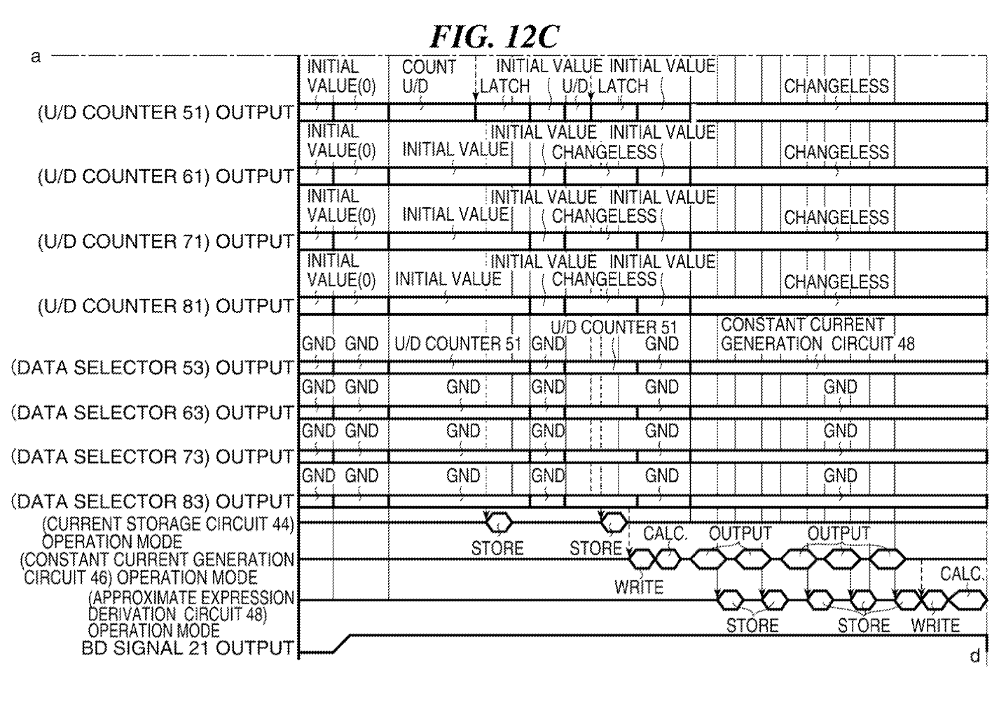

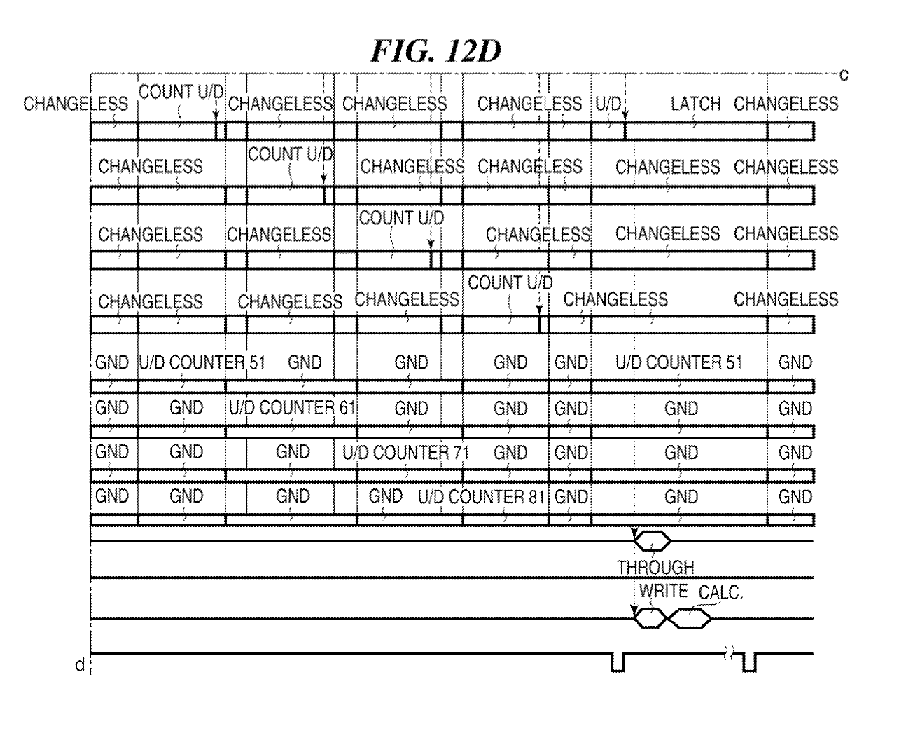

FIG. 12A through FIG. 12D show a time chart showing the light control including the approximate expression derivation control (CAL) and the initial light control (INT-APC) by the laser control device 12.

The laser control device 12 is initialized immediately after the powering-on of the image forming apparatus 1 (the “RESET” mode). The output of the switch 36 and the inputs of the data selectors 53, 63, 73, and 83 in this state are listed in fields in the initialization setting (the “RESET” mode) row shown in FIG. 11A, and no input signals other than a RESET release signal are acceptable. When the U/D counters 51, 61, 71, and 81 are initialized and the data selectors 53, 63, 73, and 83 select to output GND, the output currents of the current drive circuit 91 are intercepted to turn the semiconductor laser 11 off.

(1) Stop Sequence

The stop sequence is performed in a period from the time of power-on of the image forming apparatus 1 until the time of start of the printing operation, which is equivalent to a period in a “DISABLE” mode shown in FIG. 12A through FIG. 12D. The output of the switch 36 and the inputs of the data selectors 53, 63, 73, and 83 in this mode are listed in fields in the “DISABLE” section in FIG. 11A. The control state of the laser control device 12 for the semiconductor laser 11 is the same as the initialization state, and turns the semiconductor laser 11 off. The setting of the switch 36 is connected to the light amount detection circuit 42 in consideration of the response to control transfer.

(2) Approximate Expression Derivation Control (CAL) Sequence

In the approximate expression derivation control (CAL) sequence, three operations of (A) the light amount detection, (B) the current setting, and (C) the approximate expression derivation described below are performed. The output of the switch 36 and the inputs of the data selectors 53, 63, 73, and 83 in the respective sequences are shown in FIG. 12A through FIG. 12D. Hereafter, the case where the approximate expression for the light emitting section LD1 of the semiconductor laser 11 is derived will be described as an example.

(A) Light Amount Detection

In a light amount detection control, the driving current value (the output value of the first U/D counter 51) that drives the semiconductor laser 11 to emit the maximum light amount is determined in order to calculate a constant current setting value that is required for deriving an approximate expression. The output of the switch 36 and the inputs of the data selectors 53, 63, 73, and 83 in this control are listed in fields in the “light amount detection” row in the “approximate expression derivation” section in FIG. 11A.

When the light amount detection control is started, the state control unit 31 designates the light emitting section LD1 according to the PD selection signal 41, counts up the first U/D counter 51, and supplies a current to the light emitting section LD1 of the semiconductor laser 11. The semiconductor laser 11 starts emission and the PD unit 14 outputs the monitor current signal 15. The minimum step current (LIop) of a count-up by the first U/D counter 51 is 0.020 [mA] (≈10/512), and the count-up amount may be constant or variable.

The I-V converter 32 converts the monitor current signal 15 into the voltage signal that is amplified corresponding to the output value of the gain setting circuit 33 that is inputted from the state control unit 31. Since the monitor current signal 15 at this time becomes the value corresponding to the maximum light amount, the output value of the gain setting circuit 33 is minimized. The light amount detection circuit 42 monitors the output signal of the I-V converter 32 at every count-up of the first U/D counter 51, and outputs the light amount detection signal 43 when reaching the maximum light amount. When receiving the light amount detection signal 43, the state control unit 31 stops the count operation of the first U/D counter 51 by the counter control signal 52, and makes the first U/D counter 51 hold the value at the time. Since the output value of the first U/D counter 51 is initialized after the value held in the first U/D counter 51 is stored into the current storage circuit 44, the control state becomes the same as the above-mentioned stop Sequence.

(b) Current Setting

In a current setting control, the driving current value (the output value of the first U/D counter 51) that drives the light emitting section LD1 of the semiconductor laser 11 to emit 25% of the maximum light amount is determined in order to calculate a constant current setting value that is required for deriving an approximate expression. The output of the switch 36 and the inputs of the data selectors 53, 63, 73, and 83 in this control are listed in fields in the “current setting” row in the “approximate expression derivation” section in FIG. 11A.

After setting the output of the gain setting circuit 33 in FIG. 10A to fourfold of the minimum value, the first U/D counter 51 is counted up and the light emitting section LD1 of the semiconductor laser 11 is driven to emit the light amount of 25%. The switch 36 selects the comparator 38, and the comparator 38 outputs a coincidence signal 39 to the state control unit 31 when the input from the switch 36 becomes equal to the reference voltage supplied from the reference voltage circuit 35. When the coincidence signal 39 is inputted, the state control section 31 stops the count operation of the first U/D counter 51 by the counter control signal 52, and makes the current storage circuit 44 store the output value of the first U/D counter 51 by outputting a storage control signal 45. Next, since the output value of the first U/D counter 51 is initialized, the control state becomes the same as the above-mentioned stop sequence. On the other hand, the state control section 31 outputs a generation circuit control signal 47 to the constant current generation circuit 46, reads the output values of the first U/D counter 51 obtained in the light amount detection control and the current setting control from the current storage circuit 44, and writes the read values to the constant current generation circuit 46 to calculate five constant current values.

(C) Approximate Expression Derivation

In the approximate expression derivation control, the light emitting section LD1 of the semiconductor laser 11 is driven with the constant current values obtained by the above-mentioned current setting control to emit light sequentially, and an approximate expression is derived from the output values of the I-V converter 32. The output of the switch 36 and the inputs of the data selectors 53, 63, 73, and 83 in this control are listed in fields in the “approximate expression calculation” row in the “approximate expression derivation” section in FIG. 11A.

The constant current generation circuit 46 sequentially outputs the constant current values obtained by the current setting control to the first Isw-DAC 59 via the first data selector 53. The constant current values are converted into analog signals by the first Isw-DAC 59, and are supplied to the light emitting section LD1 of the semiconductor laser 11 as a driving current from the current drive circuit 91. The light emitting section LD1 of the semiconductor laser 11 emits light by the driving current, and the PD unit 14 outputs the corresponding monitor current signal 15 to obtain the output value of the I-V converter 32.

The approximate expression derivation circuit 48 stores the value that the output of the I-V converter 32 is digitally converted according to the calculation circuit control signal 49 inputted from the state control unit 31 when predetermined time elapses after the driving current is supplied. The predetermined time refers to a period until the monitor current signal 15 outputted from the PD unit 14 rises and is stabilized. The approximate expression derivation circuit 48 receives the five constant current values from the constant current generation circuit 46, derives an n-th degree approximate expression (n≧2) based on the outputs of the I-V converter 32 corresponding to the constant current values, calculates the threshold current for the light emitting section. LD1 of the Semiconductor laser 11 using the derived approximate expression, and stores it.

(3) Initial Light Control (INT-APC) Sequence

When the printing process starts, an initial light control (referred to as an “INT-APC” in short hereafter) is performed. The state control unit 31 selects an “INT-APC” mode based on the laser control signal 22 outputted from the image control unit 3. The output of the switch 36 and the inputs of the data selectors 53, 63, 73, and 83 in this mode are listed in fields in the “initial light amount control” section in FIG. 11A.

The PD selector 40 selects the first U/D counter 51 of the module A as the output destination of the comparator 38 based on the PD selection signal 41 inputted from the state control unit 31 in order to execute the INT-APC for the light emitting section LD1 of the semiconductor laser 11. The first U/D counter 51 starts count-up according in response to the counter control signal 52. Accordingly, the set value of the first Isw-DAC 59 at the stage increases, and an electric current is supplied to the light emitting section LD1 of the semiconductor laser 11 from the current drive circuit 91. The semiconductor laser 11 starts emission and the PD unit 14 outputs the monitor current signal 15.

The comparator 38 compares the monitor current signal 15 converted into the voltage signal by the I-V converter 32 to the reference voltage supplied from the reference voltage circuit 35. When the first U/D counter 51 continues count-up and the difference between the voltage signal based on the monitor current signal 15 and the reference voltage falls within a prescribed range, the comparator 38 outputs the coincidence signal 39 to the state control unit 31. When the voltage signal based on the monitor current signal 15 is larger than the reference voltage supplied from the reference voltage circuit 35 as a result of comparison, the first U/D counter 51 performs count-down. And when the difference falls within the prescribed range, the comparator 38 outputs the coincidence signal 39 to the state control unit 31. When the coincidence signal 39 is inputted, the state control unit 31 stops the count operation of the first U/D counter 51 by the counter control signal 52, and makes the first U/D counter 51 hold the output value.

Next, the PD selector 40 selects the second U/D counter 61 of the module B as the output destination of the comparator 38 based on the PD selection signal 41 inputted from the state control unit 31 in order to execute the INT-APC for the light emitting section LD2 of the semiconductor laser 11. After that, the INT-APC's for the light emitting sections LD3 and LD4 are executed sequentially. Since the operating state is the same as that for the light emitting section LD1, the description is omitted.

(1) BD Detection Sequence

After completion of the INT-APC, a BD detection sequence is performed. In the BD detection sequence, the signal that is obtained by receiving the beam emitted by a light emitting section (LD1 in this embodiment), which is a standard during the image formation after the'light amount is stabilized, is detected periodically. Therefore, the detection with constant light amount is desirable in view of the output delay variation due to photosensitivity of the BD sensor.

The BD detection sequence is executed by the line-to-line light control (LINE-APC) shown in FIG. 8. This control will be described below.

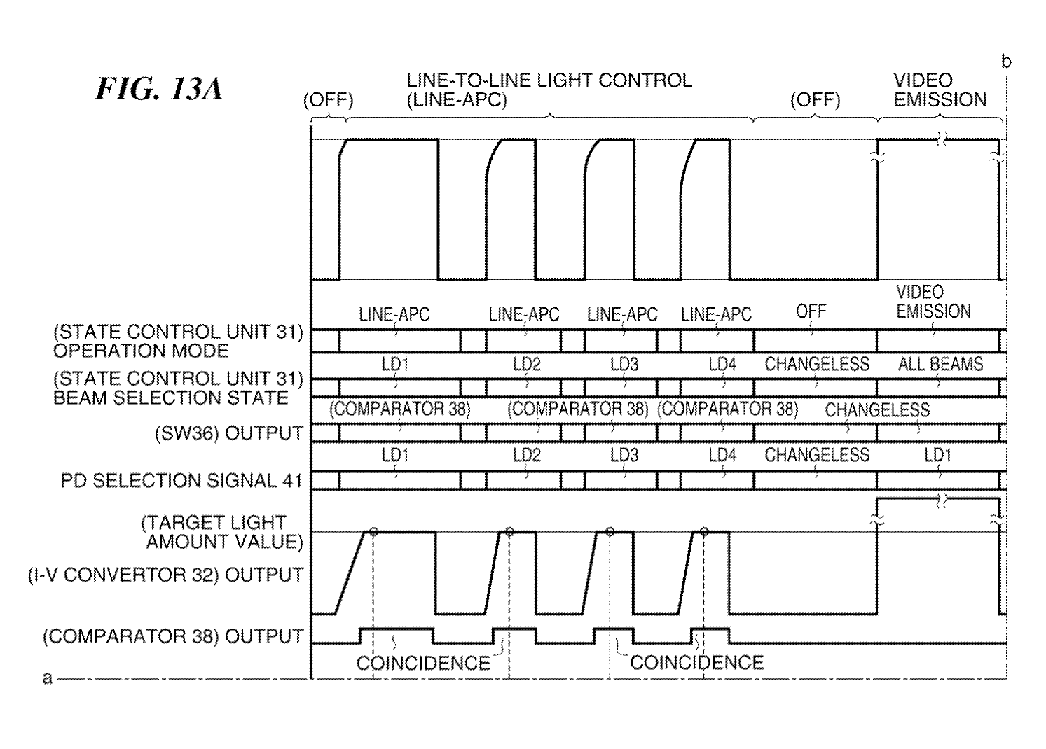

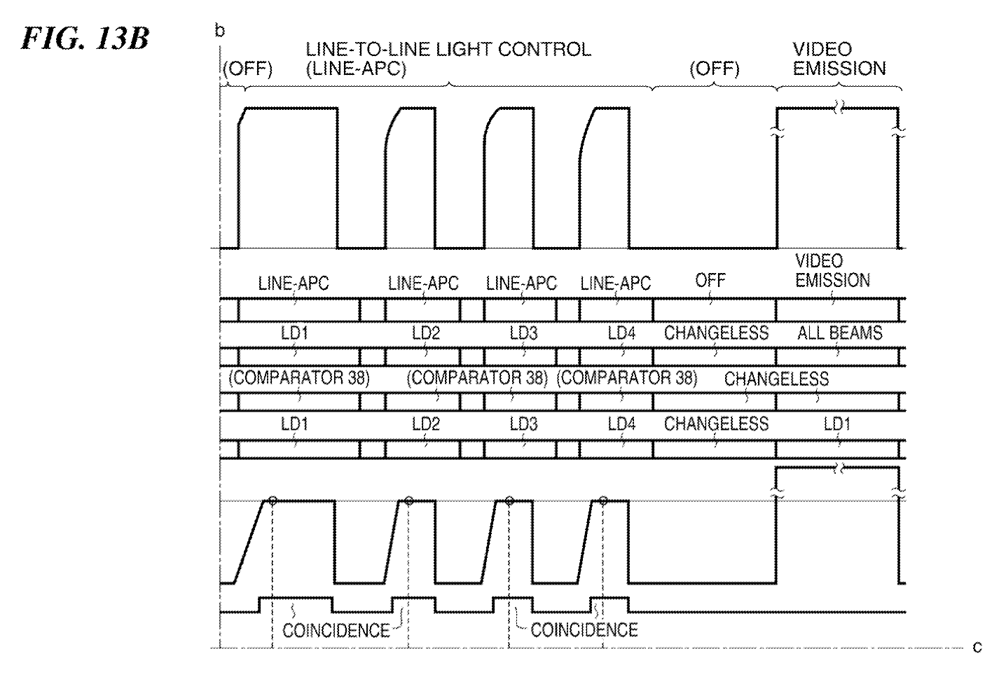

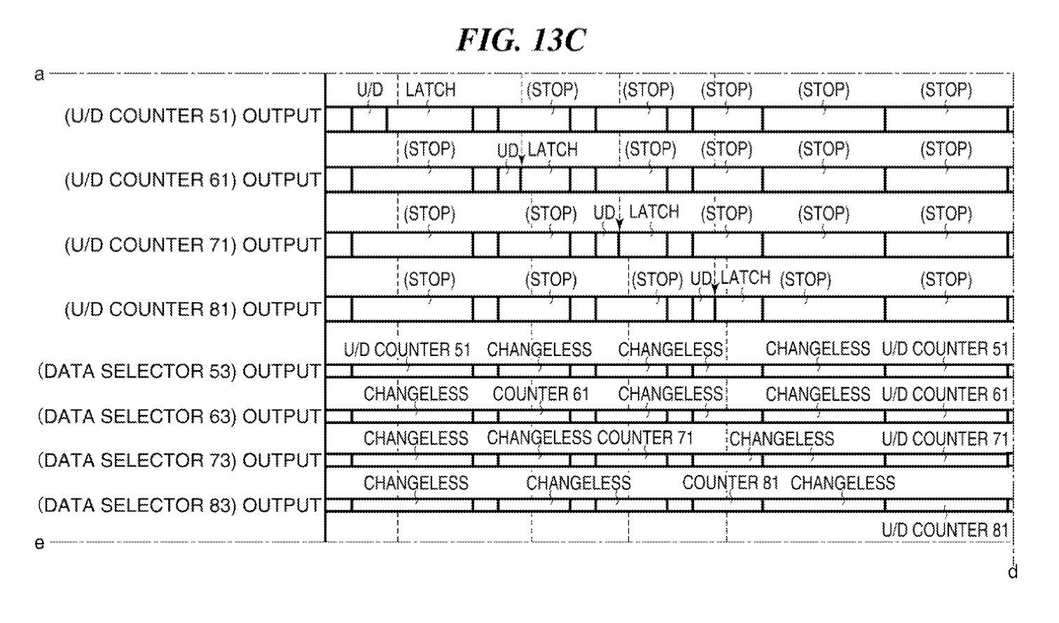

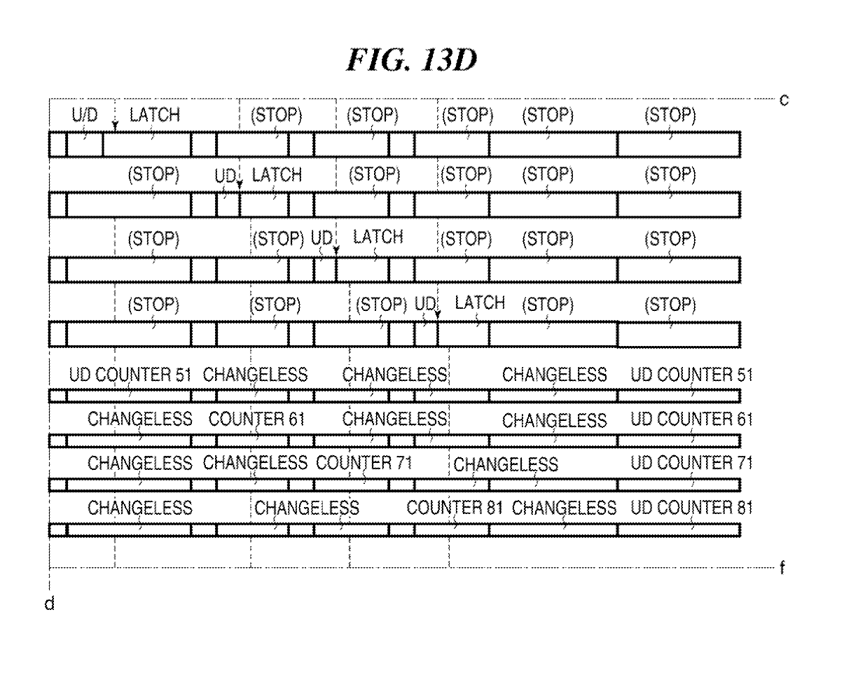

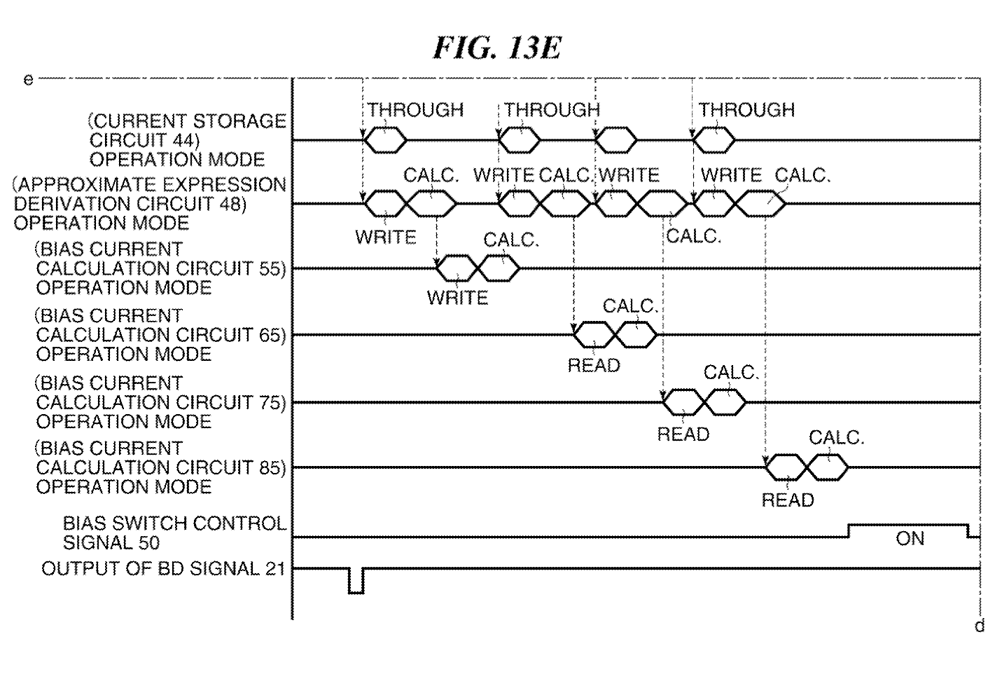

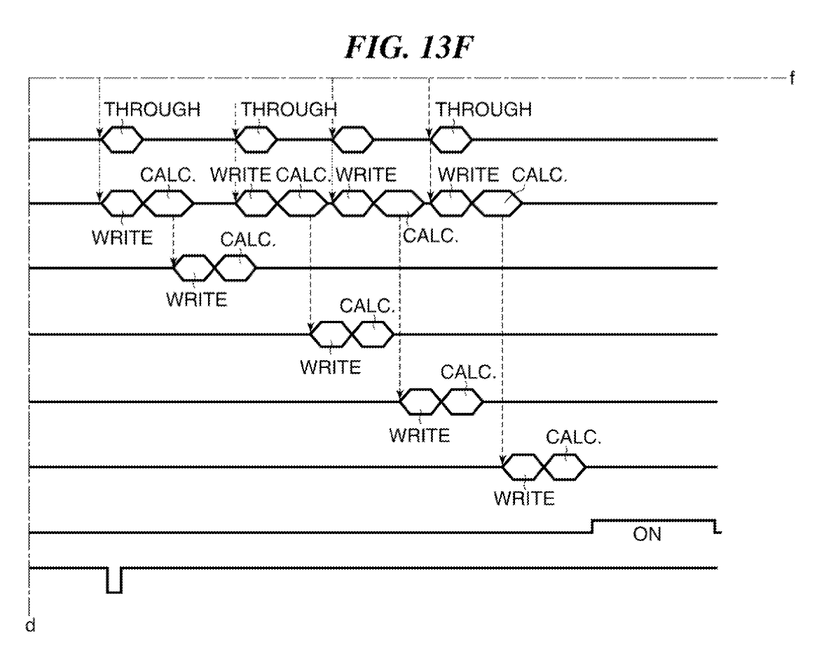

FIG. 13A through FIG. 13F show a time chart showing the light controls including the line-to-line light control (LINE-APC) by the laser control device 12.

The image control unit 3 forms a control sequence of the laser control device 12 by outputting the laser control signal 22 on the basis of the BD signal 21, when the BD signal 21 is detected at a predetermined period in the BD detection sequence.

(5) Line-to-Line Light Control (LINE-APC)

For a purpose of stabilizing density during the printing process, a line-to-line light control (referred to as a “LINE-APC” in short hereafter) is performed just before the image formation. The state control unit 31 selects a “LINE-APC” mode based on the laser control signal 22 outputted from the image control unit 3. The output of the switch 36 and the inputs of the data selectors 53, 63, 73, and 83 in this mode are listed in fields in the “line-to-line light control” section in FIG. 11A.

The PD selector 40 selects the first U/D counter 51 of the module A as the output destination of the comparator 38 based on the PD selection signal 41 inputted from the state control unit 31 in order to execute the LINE-APC for the light emitting section LD1 of the semiconductor laser 11. The first U/D counter 51 gradually counts up according to the counter control signals 52, and the current drive circuit 91 supplies the electric current to the light emitting section LD1 of the semiconductor laser 11. The semiconductor laser 11 starts emission and the PD unit 14 outputs the monitor current signal 15.

The comparator 38 compares the monitor current signal 15 converted into the voltage signal by the I-V converter 32 to the reference voltage supplied from the reference voltage circuit 35. When the first U/D counter 51 continues count-up and the difference between the voltage signal based on the monitor current signal 15 and the reference voltage falls within the prescribed range, the comparator 38 outputs the coincidence signal 39 to the state control unit 31. When the voltage signal based on the monitor current signal 15 is larger than the reference voltage supplied from the reference voltage circuit 35 as a result of comparison, the first U/D counter 51 performs count-down. And when the difference falls within the prescribed range, the comparator 38 outputs the coincidence signal 39 to the state control unit 31. When the coincidence signal 39 is inputted, the state control unit 31 stops the count operation of the first U/D counter 51 by the counter control signal 52, and makes the first U/D counter 51 hold the output value.

The approximate expression derivation circuit 48 writes the output value of the first U/D counter 51 via the current storage circuit 44, calculates a difference value from the threshold current acquired by the “approximate expression derivation” sequence, and takes it as the threshold current for the light emitting section LD1. The threshold current for the light emitting section LD1 of the semiconductor laser 11 is re-calculated because of corresponding to the threshold current shift by temperature changes. The first bias current calculation circuit 55 calculates the threshold current calculated by the approximate expression derivation circuit 48 based on the first bias setting signal 56, and outputs it to the first Ib-DAC 60.

Next, the PD selector 40 selects the second U/D counter 61 of the module B as the output destination of the comparator 38 based on the PD selection signal 41 inputted from the state control unit 31 in order to execute the LINE-APC for the light emitting section LD2 of the semiconductor laser 11. After that, the LINE-APC's for the light emitting sections LD3 and LD4 are executed sequentially. Since the operating state is the same as that for the light emitting section LD1, the description is omitted. Thus, the driving currents for the light emitting sections L1 through L4 of the semiconductor laser 11 that emitted the predetermined laser beams according to the constant currents outputted from the bias current calculation circuits 55, 65, 75, and 85 are changed whenever the approximate expression derivation circuit 48 derives the n-th degree approximate expression.

(6) Image Formation Sequence

An image formation sequence is performed after completion of the LINE-APC. The state control unit 31 selects a “VIDEO EMISSION” mode based on the laser control signal 22 outputted from the image control unit 3. The output of the switch 36 and the inputs of the data selectors 53, 63, 73, and 83 in this mode are listed in fields in the “VIDEO EMISSION” section in FIG. 11A.

In the “VIDEO EMISSION” mode, the bias switches 57, 67, 77, and 87 are short-circuited so that the outputs of the Isw-DAC's 59, 69, 79, and 89 are equal to the values obtained by subtracting the output values of the bias current calculation circuits 55, 65, 75, and 85 from the driving currents obtained by the LINE-APC. Therefore, the electric current supplied to the light emitting section LD1 of the semiconductor laser 11 is obtained by adding the outputs of the Isw-DAC's 59, 69, 79, and 89 to the output of the first Ib-DAC 60. Further, the electric current is modulated by the image data 23p and 23n inputted from the image control unit 3 via the data driver 92.

According to the above-mentioned embodiment, the nonlinearity of the luminescent characteristic (current-light amount characteristic) of the multi-beam semiconductor laser can be corrected. Since the bias currents for laser beams are set using the n-th degree approximate expression (n is not larger than the number of all the beams), APC time can be shortened.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-064198, filed on Mar. 23, 2011, which is hereby incorporated by reference herein in its entirety.

What is claimed is:

1. An optical scanning device that scans an image bearing member with a laser beam emitted from a semiconductor laser modulated based on an image signal, comprising:
an electric current supply unit configured to supply one of a bias current and a driving current, which includes the bias current and a pulse current based on the image data, to the semiconductor laser;
a detection unit configured to detect light amount of the laser beam emitted from the semiconductor laser; and
a control unit configured to control the value of the driving current supplied to the semiconductor, laser based on the light amount detected by said detection unit so that the light amount of the laser beam to which the image bearing member is exposed becomes a predetermined light amount,
wherein said control unit comprising:
a constant current generation unit configured to generate a plurality of constant currents;
a calculation unit configured to derive an n-th degree approximate expression (n≧2) of a current-light characteristic based on the light amount detected by said detection unit by emitting a specific light emitting section of the semiconductor laser according to the constant currents generated by said constant current generation unit, and to calculate a light emission start current value for the specific light emitting section using the n-th degree approximate expression concerned; and
a bias current generation unit configured to generate the bias current based on electric current values obtained from results of light controls for light emitting sections other than the specific light emitting section and the n-th degree approximate expression derived by said calculation unit.

2. The optical scanning device according to claim 1, wherein said constant current generation unit determines the constant currents between the maximum driving current supplied to the semiconductor laser when emitting the possible maximum light amount and the minimum driving current supplied to the semiconductor laser when emitting light amount of predetermined percentage of the maximum light amount.

3. The optical scanning device according to claim 1, wherein the driving currents for the light emitting sections of the semiconductor laser that emitted laser beams according to the constant currents outputted from said constant current generation unit are changed whenever said calculation unit derives the n-th degree approximate expression.

4. The optical scanning device according to claim 1, wherein the light emission start current value Ith and the bias current Ib satisfy the relation of Ib=αIth (α≦1).

5. A light control method for an optical scanning device that scans an image bearing member with a laser beam emitted from a semiconductor laser modulated based on an image signal, the light control method comprising:
a light amount detection step of detecting light amount of the laser beam emitted from the semiconductor laser; and
a light control step of controlling the value of the driving current supplied to the semiconductor laser based on the light amount detected in said light amount detection step so that the light amount of the laser beam to which the image bearing member is exposed becomes a predetermined light amount,
wherein said light control step comprising:
a constant current generation step of generating a plurality of constant currents;
a calculation step of deriving an n-th degree approximate expression (n≧2) of a current-light characteristic based on the light amount detected in said, light amount detection step by emitting a specific light emitting section of the semiconductor laser according to the constant currents generated in said constant current generation step, and of calculating a light emission start current start current for the specific light emitting section using the n-th degree approximate expression concerned; and
a bias current generation step of generating the bias current based on electric current values obtained from results of light controls for light emitting sections other than the specific light emitting section and the n-th degree approximate expression derived in said calculation step.

6. An image forming apparatus provided with the optical scanning device according to claim 1.
